(19) United States
(12) Patent Application Publication
(10) Pub. No.: US 2006/0130779 A1
(43) Pub. Date: Jun. 22, 2006

(54) Water level detection apparatus for secondary water tank of radiator of wheeled vehicle

(76) Inventor: Chun-Ta Wei, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/015,251

(22) Filed: Dec. 20, 2004

(51) Int. Cl. F01P 5/14; F01P 3/22; B60Q 1/00

(52) U.S. Cl. 123/41.15; 123/41.54; 340/450

(57) ABSTRACT

A water level detection apparatus for a secondary water tank of a radiator of a wheeled vehicle includes a water level detection element mounted in the secondary water tank, and a warning device connected to and controlled by the water level detection element to provide a warning effect when the water level detection element detects that the water level of the secondary water tank is smaller than the predetermined value. Thus, when the cooling water of the cooling system of the wheeled vehicle is located at the lower water level due to leakage or evaporation, the warning device is started to emit a warning signal to inform the driver of the abnormal condition, so that the driver can replenish the cooling water and check the circulating system of the water tank.

### BACKGROUND OF THE INVENTION

1. Field of the Invention

The present invention relates to a water level detection apparatus, and more particularly to a water level detection apparatus for a secondary water tank of a radiator of a wheeled vehicle.

2. Description of the Related Art

A conventional radiator of a wheeled vehicle comprises a main water tank, and a secondary water tank connected to the main water tank to store a cooling water from the main water tank when the main water tank is subjected to a higher pressure provided by the cooling water of the engine. After the temperature of the cooling water of the engine is lowered down, the cooling water delivered into the secondary water tank is returned into the main water tank. The wheeled vehicle is often provided with an engine temperature gauge to remind the driver of overheat of the engine to prevent the engine from being worn out.

However, when the engine temperature is too high due to the water level of the cooling water being too low, the driver has to replenish the cooling water when the engine temperature is reduced to the normal temperature, thereby causing inconvenience to the driver. In addition, the engine may be worn out due to overheat caused by lack of the cooling water before the cooling water is replenished.

### SUMMARY OF THE INVENTION

In accordance with the present invention, there is provided a radiator, comprising a main water tank, a secondary water tank connected to the main water tank, and a water level detection apparatus mounted on the secondary water tank to detect a water level of an inside of the secondary water tank.

The primary objective of the present invention is to provide a water level detection apparatus for a secondary water tank of a radiator of a wheeled vehicle to detect if the cooling water of the secondary water tank is located at the lower water level.

Another objective of the present invention is to provide a water level detection apparatus, wherein when the cooling water of the cooling system of the wheeled vehicle is located at the lower water level due to leakage or evaporation, the water level detection element of the warning device can detects the abnormal condition of the water level of the cooling water, and the warning element of the warning device is started to emit a warning signal so as to inform the driver of the abnormal condition, so that the driver can replenish the cooling water instantaneously and check the circulating system of the water tank by warning of the warning device to ensure that the engine is operated at the normal temperature, thereby preventing the engine from being worn out due to overheat.

Further benefits and advantages of the present invention will become apparent after a careful reading of the detailed description with appropriate reference to the accompanying drawings.

### BRIEF DESCRIPTION OF THE DRAWINGS

FIG. 1 is a plan view of a water level detection apparatus for a secondary water tank of a radiator of a wheeled vehicle in accordance with the preferred embodiment of the present invention; and

FIG. 2 is a schematic operational view of the water level detection apparatus as shown in FIG. 1 in use.

### DETAILED DESCRIPTION OF THE INVENTION

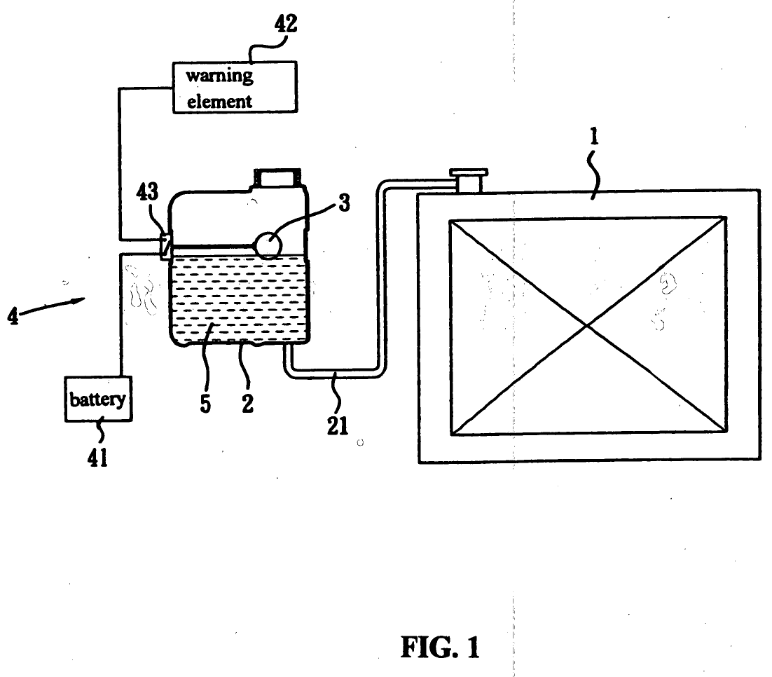

Referring to the drawings and initially to FIG. 1, a radiator (or water tank) of a wheeled vehicle in accordance with the preferred embodiment of the present invention comprises a main water tank 1, a secondary water tank 2 connected to the main water tank 1, and a water level detection apparatus mounted on the secondary water tank 2 to detect a water level of an inside of the secondary water tank 2.

The main water tank 1 has a plurality of smaller pipes (not shown) and a plurality of cooling fins (not shown) mounted on the smaller pipes. The main water tank 1 is connected to an inlet (not shown) and an outlet (not shown) of an engine (not shown) by pipes (not shown) respectively, so that the cooling water is circulating between the main water tank 1 and the engine to form a heat-exchange effect.

The inside of the secondary water tank 2 contains a cooling water 5 and is connected to the main water tank 1 by a pipe 21.

The water level detection apparatus includes a water level detection element 3 mounted in the inside of the secondary water tank 2 to detect if the water level of the inside of the secondary water tank 2 is smaller than a predetermined value, and a warning device 4 mounted on a proper position of the wheeled vehicle (such as the instrument panel) and connected to and controlled by the water level detection element 3 to provide a warning effect when the water level detection element 3 detects that the water level of the inside of the secondary water tank 2 is smaller than the predetermined value.

In the preferred embodiment of the present invention, the water level detection element 3 is a float floating on the cooling water 5 of the secondary water tank 2.

The warning device 4 includes a switch 43 mounted on the secondary water tank 2 triggered by the water level detection element 3, a warning element 42 connected to and operated by the switch 43, and a battery 41 connected to the switch 43 and the warning element 42 to supply an electric power to the warning element 42.

The warning element 42 is a lighting bulb, a buzzer, an indication scale or the like. The switch 43 is triggered by touching or induction of the water level detection element 3 so as to connect the warning element 42 to the battery 41. Thus, when the switch 43 is conducted by the water level detection element 3, the warning element 42 lights or emits a warning sound.

As shown in FIG. 1, when the water level of the cooling water 5 of the secondary water tank 2 is greater than the predetermined value, the water level detection element 3 is floated, so that the switch 43 of the warning device 4 is not conducted, and the warning element 42 of the warning device 4 is not operated.

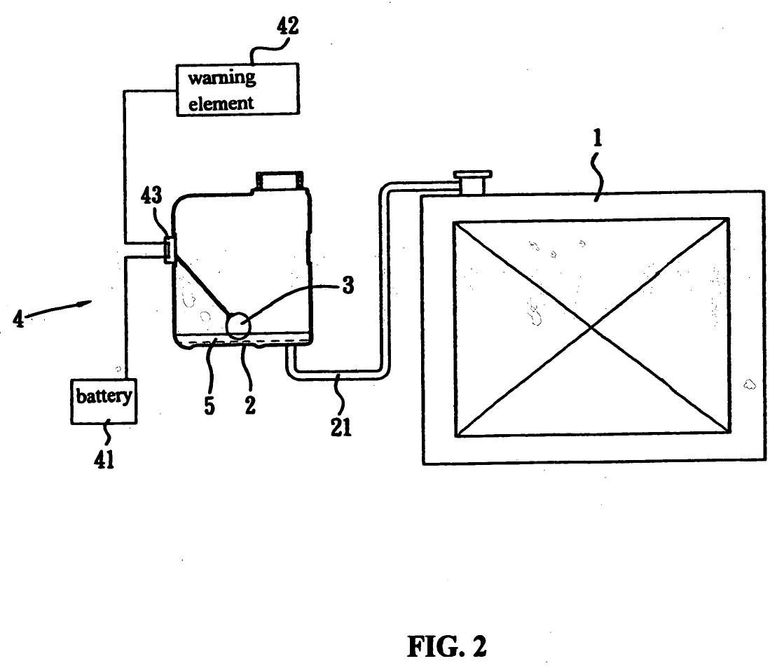

As shown in FIG. 2, when the water level of the cooling water 5 of the secondary water tank 2 is smaller than the predetermined value, the water level detection element 3 is lowered, so that the switch 43 of the warning device 4 is conducted by touching or induction of the water level detection element 3, and the warning element 42 of the warning device 4 is started to light or emit a warning sound so as to inform the driver that the cooling water 5 of the secondary water tank 2 is located at the lower water level. Thus, the driver can replenish the cooling water 5 and check the circulating system of the water tank by warning of the warning device 4.

Accordingly, when the cooling water of the cooling system of the wheeled vehicle is located at the lower water level due to leakage or evaporation, the water level detection element 3 of the warning device 4 can detects the abnormal condition of the water level of the cooling water, and the warning element 42 of the warning device 4 is started to emit a warning signal so as to inform the driver of the abnormal condition, so that the driver can replenish the cooling water 5 instantaneously and check the circulating system of the water tank by warning of the warning device 4 to ensure that the engine is operated at the normal temperature, thereby preventing the engine from being worn out due to overheat.

In another embodiment of the present invention, the water level detection element 3 is a liquid level detector connected to the warning element 42 by a connecting wire and having a bottom provided with a detection portion located in the lower water level of the secondary water tank 2, so that when the cooling water 5 of the secondary water tank 2 is located at the predetermined lower water level, the warning element 42 of the warning device 4 is started to light or emit a warning sound so as to inform the driver that the cooling water 5 of the secondary water tank 2 is located at the lower water level.

In another embodiment of the present invention, the water level detection element 3 is connected to the warning element 42 and includes a float mounted in the secondary water tank 2 and having a magnetic body, and a detector mounted on an outside of the secondary water tank 2 and provided with a reed switch. Thus, when the float is lifted and the magnetic body of the float is moved to approach the reed switch of the detector to form a magnetic circuit, the warning element 42 is not operated. Alternatively, when the water level of the cooling water 5 of the secondary water tank 2 is smaller than the predetermined value, the float is lowered and the magnetic body of the float is moved to leave the reed switch of the detector to interrupt the magnetic circuit, so that the warning element 42 is started to light or emit a warning sound so as to inform the driver that the cooling water 5 of the secondary water tank 2 is located at the lower water level. Thus, the driver can replenish the cooling water 5 and check the circulating system of the water tank by warning of the warning device 4.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A radiator, comprising:
a main water tank;
a secondary water tank connected to the main water tank;
a water level detection apparatus mounted on the secondary water tank to detect a water level of an inside of the secondary water tank.

2. The radiator in accordance with claim 1, wherein the water level detection apparatus includes:
a water level detection element mounted in the inside of the secondary water tank to detect if the water level of the inside of the secondary water tank is smaller than a predetermined value;
a warning device connected to and controlled by the water level detection element to provide a warning effect when the water level detection element detects that the water level of the inside of the secondary water tank is smaller than the predetermined value.

3. The radiator in accordance with claim 2, wherein the water level detection element is a float floating on a cooling water of the secondary water tank.

4. The radiator in accordance with claim 2, wherein the warning device includes:
a switch mounted on the secondary water tank triggered by the water level detection element;
a warning element connected to and operated by the switch;
a battery connected to the switch and the warning element to supply an electric power to the warning element.

5. The radiator in accordance with claim 4, wherein the warning element is a lighting bulb.

6. The radiator in accordance with claim 4, wherein the warning element is a buzzer.

7. The radiator in accordance with claim 4, wherein the warning element is an indication scale.

8. The radiator in accordance with claim 4, wherein the switch is triggered by touching of the water level detection element so as to connect the warning element to the battery.

9. The radiator in accordance with claim 4, wherein the switch is triggered by induction of the water level detection element so as to connect the warning element to the battery.

10. The radiator in accordance with claim 2, wherein the water level detection element includes a liquid level detector connected to the warning element.

11. The radiator in accordance with claim 2, wherein the water level detection element is connected to the warning element and includes a float mounted in the secondary water tank and having a magnetic body, and a detector mounted on an outside of the secondary water tank and provided with a reed switch.
